(19) United States
(12) Patent Application Publication
(10) Pub. No.: US 2024/0388170 A1
(43) Pub. Date: Nov. 21, 2024

(54) AN ELECTRICAL GENERATOR AND COOLING SYSTEM

(71) Applicant: General Electric Company, Schenectady, NY (US)

(72) Inventor: Ernst Wolfgang Stautner, Niskayuna, NY (US)

(21) Appl. No.: 18/578,972

(22) PCT Filed: Jul. 13, 2021
(86) PCT No.: PCT/US2021/041362

§ 371 Date: Jan. 12, 2024

(51) Int. Cl. H02K 9/20; H02K 5/20; H02K 55/02

(52) U.S. Cl. CPC H02K 9/20; H02K 5/203; H02K 55/02

(57) ABSTRACT

An electrical generator and cooling system for the same are provided. Accordingly, the generator includes a non-rotatable component supporting a field winding assembly and a rotatable component oriented to rotate relative thereto. The generator also includes an armature winding assembly fixedly coupled to the rotatable component so as to rotate therewith during operation of the generator. The generator also includes a cooling system operably coupled to the field winding assembly. The cooling system includes at least one reservoir unit and a plurality of expansion units. The cooling system also includes a conduit network configured to circulate a portion of cooling fluid adjacent to the field winding assembly to cool the field winding assembly. Additionally, the cooling system includes a first and a second plurality of toroidal expansion units circumscribing an axis of the generator.

### FIELD

The present disclosure relates in general to generators, and more particularly to cooling systems for generators.

### BACKGROUND

Wind turbines have received increased attention as an environmentally safe and relatively inexpensive alternative energy source. With this growing interest, considerable efforts have been made to develop wind turbines that are reliable and efficient.

Generally, a wind turbine includes a plurality of blades coupled via the rotor hub to the main shaft of the turbine. The rotor hub is positioned on top of a tubular tower or base. Utility grade wind turbines (i.e., wind turbines designed to provide electrical power to a utility grid) can have large rotors (e.g., 100 or more meters in diameter). The rotor blades convert wind energy into a rotational torque or force that drives the generator, rotationally coupled to the rotor.

Low reactance machines (e.g., superconducting generators) are being explored for use in wind turbine installations, particularly in offshore installations. These machines use superconducting field windings and assemblies of armature coils, cooling systems, and nonmagnetic teeth disposed between coils in the armature. In a particular design, the superconducting generator includes an armature assembly that, unlike conventional machine (e.g., conventional, non-superconducting generator) configurations, rotates within a superconducting field assembly, which includes a cryostat with superconducting field coils inside the cryostat.

With a superconducting generator, it is typically desirable to cool the field winding assembly. This may be accomplished via a cooling system employing a cooling fluid (e.g., a cryogenic fluid such as liquid/gaseous helium). The cooling fluid is typically stored in a pressure vessel at low temperatures for delivery to the field winding assembly. In a closed-loop cooling system, a fixed amount of cooling fluid is maintained within the system. As such, the pressure vessel must be sized to maintain both a liquid volume and a gaseous volume of the cooling fluid. However, this sizing may permit the liquid volume of the cooling fluid to slosh within the pressure vessel, thereby raising the temperature of the liquefied cooling fluid. Typically, the sloshing is mitigated via a plurality of intersecting planar baffles inserted within the pressure vessel. Additionally, the required size of the pressure vessel may necessitate compliance with certain testing requirements corresponding to pressure-volume product limits. Further, the required size of the pressure vessel may exceed the internal volume of the nacelle of the wind turbine that is available for the generator/cooling system.

In view of the aforementioned, the art is continuously seeking new and improved generators and cooling systems.

### BRIEF DESCRIPTION

Aspects and advantages of the invention will be set forth in part in the following description, or may be obvious from the description, or may be learned through practice of the invention.

In one aspect, the present disclosure is directed to a generator. The generator may include a non-rotatable component supporting a field winding assembly. The non-rotatable component may extend between a first axial position and a second axial position and have an annular cross-sectional shape circumscribing an axis. The generator may also include an armature winding assembly fixedly coupled to a rotatable component so as to rotate therewith relative to the non-rotatable component during an operation of the generator. Additionally, the generator may include a cooling system operably coupled to the field winding assembly. The cooling system may include at least one reservoir unit containing a cooling fluid in a liquid state. The cooling system may also include a plurality of expansion units containing the cooling fluid in a gaseous state fluidly coupled to the at least one reservoir unit. Additionally, the cooling system may include a conduit network fluidly coupled to the at least one reservoir unit configured to circulate a portion of the cooling fluid adjacent to the field winding assembly so as to cool the field winding assembly. Further, the cooling system may include a first plurality of toroidal expansion units circumscribing the axis adjacent the first axial position, and a second plurality of toroidal expansion units circumscribing the axis adjacent the second axial position, wherein each toroidal expansion unit of the first and second pluralities of toroidal expansion units has an enclosed volume defined by a tubular wall, wherein the first and second pluralities of toroidal expansion units are fluidly coupled to the conduit network.

In another aspect, the present disclosure is directed to a wind turbine. The wind turbine may include a rotor having a plurality of rotor blades; and a superconducting generator operably coupled to the rotor and positioned a nacelle of the wind turbine. The superconducting generator may include any of the features and/or elements described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine having a generator according to the present disclosure;

FIG. 2 illustrates a simplified cross-sectional view of a longitudinal portion of the generator for use with the wind turbine according to the present disclosure;

FIG. 3 illustrates a simplified cross-sectional view of a lateral portion of the generator for use with the wind turbine according to the present disclosure; and

FIG. 4 illustrates a schematic diagram of a portion of the cooling system according to the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Generally, the present disclosure is directed to the cooling of the windings of a generator. In particular, the cooling system, which may be a cryogenic cooling system, may include at least one reservoir unit containing a cooling fluid in a liquid state and a plurality of expansion units containing the cooling fluid in a gaseous state, as opposed to a pressure vessel containing both liquid and gaseous cooling fluid. Additionally, the cooling system may include a first and a second plurality of toroidal expansion units which circumscribe an axis of the generator.

For example, the cooling system may be a closed-loop, thermosiphon cryogenic cooling system. As such, the reservoir unit(s) may be positioned above the field winding assembly of the generator. This positioning may facilitate the delivery of a portion of the cooling fluid into a conduit network of the cooling system via a gravity feed (e.g., in the absence of pumps). As such, the thermosiphon cryogenic cooling system may be considered to be a passive cooling system, as opposed to an active cooling system that relies on at least one pump to circulate the cooling fluid. Additionally, the plurality of expansion units may be positioned above the reservoir unit(s) and adjacent thereto. In such a configuration, a quantity of heat may be transferred from the field winding assembly to the cooling fluid resulting in a plurality of gaseous bubbles being entrained by the cooling fluid and the generation of a current within the cooling fluid toward a recondenser and, ultimately, the reservoir unit(s)/plurality of expansion units.

The employment of the combination of the reservoir unit(s) and the plurality of expansion units may provide multiple advantages over the utilization of pressure vessels sized to contain both liquid and gaseous portions of the cooling fluid (e.g., a single pressure tank). For example, the utilization of the reservoir unit(s) containing only liquid cooling fluid may mitigate/eliminate sloshing of the cooling fluid. This, may, in turn, mitigate the warming of the cooling fluid that may result from the conversion of the mechanical energy of the sloshing to heat. Insofar as the combination of the reservoir unit(s) and the plurality of expansion units may not be susceptible to sloshing, the requirement to form the units with baffles may, thus, be eliminated. This may, in turn, reduce the cost and complexity of the cooling system.

Additionally, the reservoir unit(s) and the plurality of expansion units may be sized so as to have a maximal pressure-volume product which is less than a pressure-volume testing limit (e.g., a TÜV Rheinland testing limit). By establishing the maximal pressure-volume product at a level below the pressure-volume testing limit, expenses and delays associated with the more rigorous testing required above the pressure-volume testing limit may be precluded.

Further, the utilization of the reservoir unit(s) and the plurality of expansion units may facilitate unit arrangements which reduce the cross-sectional area of the generator relative to generators employing a pressure vessel sized to contain both the liquid and gaseous cooling fluid. For example, known generators may employ a single pressure vessel as the storage tank configured to support pressures of 10 to 15 MPa. The cross-sectional area of such a generator may exceed certain spatial design restrictions of the wind turbine. In other words, employing a single bulky storage tank may result in a generator which does not fit within the available space within the nacelle of the wind turbine. Such a consequence may be mitigated/eliminated through the spatial flexibility afforded by the utilization of the array of the reservoir unit(s)/expansion units.

As stated previously, the cooling system may include a first and a second plurality of toroidal expansion units. The plurality of toroidal expansion units may be employed during a cooldown operation wherein the temperature of the field coil assembly is brought into a cryogenic range. Additionally, the pluralities of toroidal expansion units serve as a reservoir to receive gaseous cooling fluid in the event of a cooling system malfunction. In other words, the pluralities of toroidal expansion units serve as a safety feature whereby unanticipated portions of the gaseous cooling fluid may be captured and recovered without damaging other components of the cooling system.

In known generators, the functions of the pluralities of toroidal expansion units are typically performed by a pair of toroidal tanks positioned axially at either end of the generator. However, the size of each of the toroidal tanks precludes the cost-effective encapsulation of the toroidal tanks within the thermal barrier surrounding the field winding assembly. As such, employing the first plurality of toroidal expansion units in lieu of the first toroidal tank and the second plurality of toroidal expansion units in lieu of the second toroidal tank may be particularly advantageous.

For example, the cumulative cross-sectional area of pluralities of toroidal expansion units may replicate the cross-sectional area of the corresponding toroidal tank but may be arranged in such a manner so as to facilitate encapsulation by the thermal barrier. Placing the pluralities of toroidal expansion units within the thermal barrier may increase the effectiveness of the cooling system over known cooling systems relying on toroidal tanks. Additionally, each toroidal expansion unit may be sized to have a maximal pressure-volume product which is less than the pressure-volume testing limit. As stated previously, by establishing the maximal pressure-volume product at a level below the pressure-volume testing limit, the expenses and delays associated with the more rigorous testing required above the pressure-volume testing limit may be precluded. This, in turn, may reduce the costs of the cooling system.

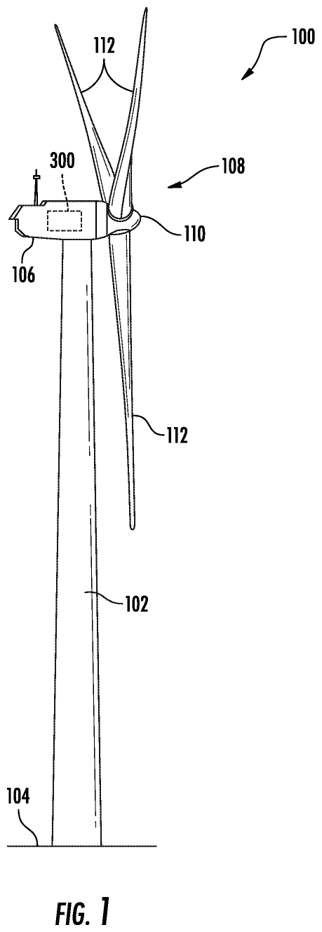

Referring now to the drawings, FIG. 1 illustrates a perspective view of one embodiment of a wind turbine 100 which may include a generator 300 according to the present disclosure. It should be appreciated that the generator 300 may be a superconducting generator having at least one superconducting winding. It should further be appreciated that the utilization of the generator 300 in the wind turbine 100 is offered by way of a nonlimiting example. Accordingly, the generator 300 is not limited to employment in the wind turbine 100 but may be configured as any suitable electrical generator or electrical motor wherein the cooling of a winding assembly may be desirable.

In an embodiment, the wind turbine 100 may generally include a tower 102 extending from a support surface 104. In an embodiment, the support surface may be land, such as for an onshore wind turbine. In an additional embodiment, the support surface may be water or a foundation emanating from the ocean floor, such as for an offshore wind turbine. A nacelle 106 may be mounted on the tower 102, and a rotor 108 coupled to the nacelle 106. The rotor 108 may include a rotatable hub 110 and at least one rotor blade 112 coupled to, and extending outwardly from, the hub 110. For example, in the illustrated embodiment, the rotor 108 includes three rotor blades 112. However, in an additional embodiment, the rotor 108 may include more or less than three rotor blades 112. Each rotor blade 112 may be spaced about the hub 110 to facilitate rotating the rotor 108 to enable kinetic energy to be transferred from the wind into usable mechanical energy, and subsequently, electrical energy. For instance, the hub 110 may be rotatably coupled to the electrical generator 300 to permit electrical energy to be produced.

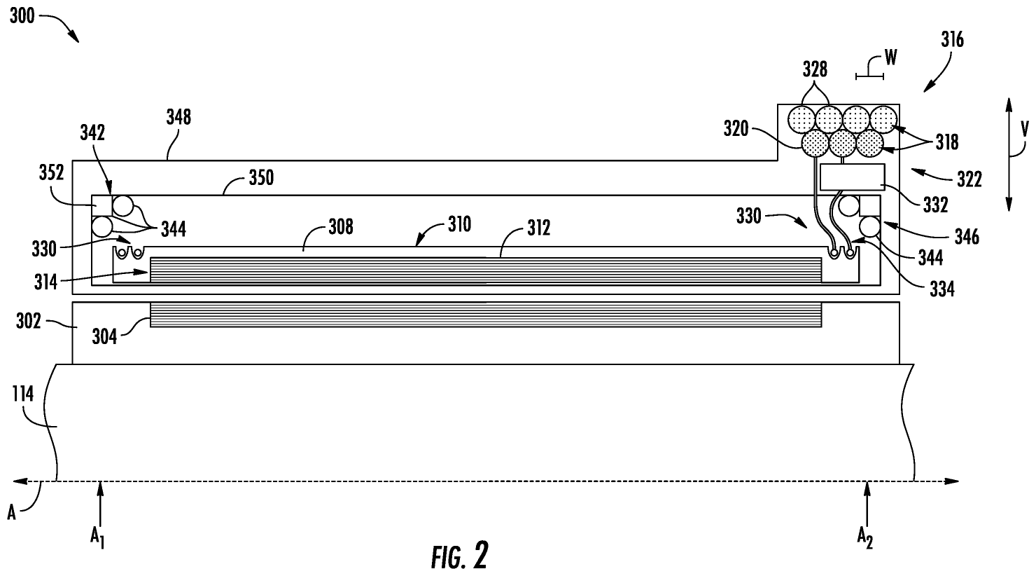

Referring now to FIG. 2, wherein a simplified cross-sectional view of an upper longitudinal portion of the generator 300 is illustrated. The generator 300 may be coupled to the hub 110 for producing electrical power from the rotational energy generated by the rotor 108. A main shaft 114 is connected directly to the hub 110 and supports the rotatable component 302 (including at least one armature winding assembly 304). Thus, the rotatable component 302 may be configured to rotate about the axis (A) in response to the rotational energy generated by the rotor 108.

In an embodiment, the rotatable component 302 may be arranged to be coaxial with a non-rotatable component 308 about axis (A). Accordingly, the rotatable component 302 and the non-rotatable component 308 may be coaxial with the rotor 108. In an embodiment, the armature winding assembly 304 may be configured to rotate with the rotatable component 302 about the axis (A) and radially inward of a field winding assembly 310 supported by the non-rotatable component 308.

As depicted in FIG. 2, in an embodiment wherein the generator 300 is configured as a superconducting generator, the field winding assembly 310 may be a superconducting field winding assembly 310. Accordingly, the field winding assembly 310 may include superconducting coils 312, which may be a group of wires formed in a racetrack shape.

In an embodiment, the superconducting coils 312 may be constrained to retain the racetrack shape, such as by a structure of the non-rotatable component 308. As such, each superconducting coil 312 may be supported in a recess/passage 314 of the non-rotatable component 308. Each recess/passage 314 may facilitate cooling each superconducting coil 312, via a bath of helium, to cryogenic temperatures or by other known methods within the engineering field of cryogenics.

The superconducting coils 312 may, in an embodiment, be arranged side-by-side in an annular array extending around the non-rotatable component 308. The non-rotatable component 308 may extend between a first axial position (A₁) and a second axial position (A₂). For example, thirty-six (36) coils 312 may form an annular array of field windings that serve as the stator field winding for the generator 300.

In an embodiment, the superconducting coils 312 may be each formed of (NbTi or other superconducting) wire wrapped in a helix around a racetrack form that may include cooling conduits for the helium. The superconducting field winding assembly 310 may include superconducting coil magnets, which are enclosed in the non-rotatable component 308 and receive cryogen through cooling recesses/passages 314.

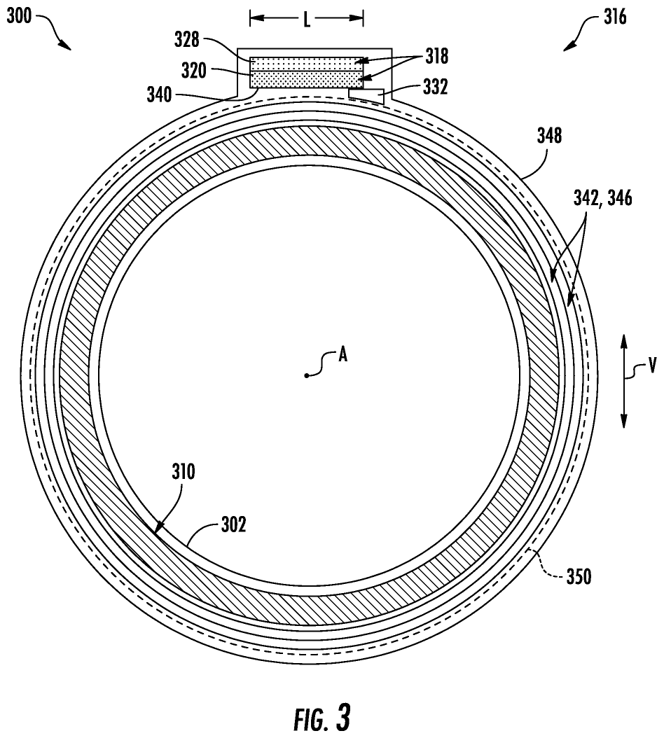

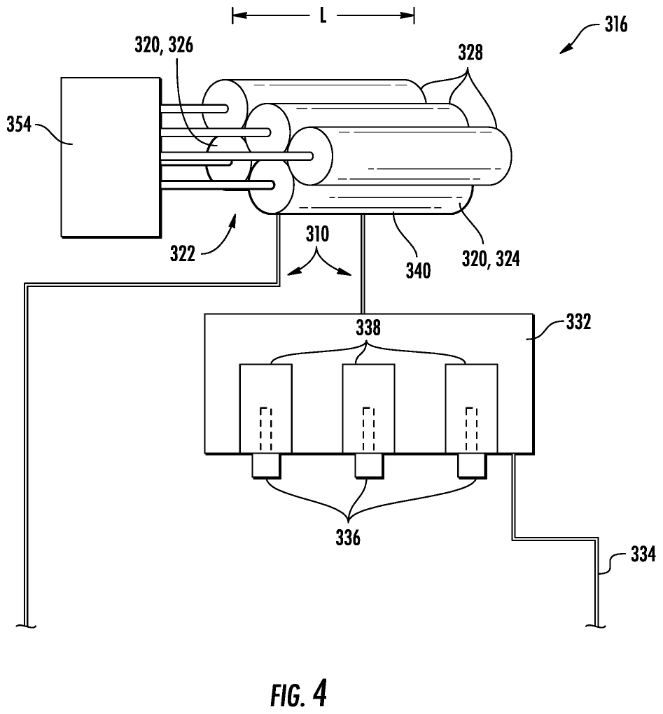

As further depicted in FIG. 2, and also in FIGS. 3 and 4, the generator 300 may, in an embodiment, include a cooling system 316. The cooling system 316 may be operably coupled to the field winding assembly 310. The cooling system 316 may be configured to deliver a cooling fluid 318 in a liquid state to the field winding assembly 310. For example, in an embodiment, the superconducting coils 312 of the generator 300 may be insulated in order to permit the cooling of the superconducting coils 312 to near absolute 0, e.g., to 10 Kelvin (K) and preferably to less than 5 K (e.g., to 4 K). In an additional embodiment, the superconducting coils 312 may be insulated in order to permit the cooling of the superconducting coils 312 to at least 50 K (e.g., at least 40 K).

The cooling system 316 may, in an embodiment, include at least one reservoir unit 320. The reservoir unit(s) 320 may contain the cooling fluid 318 in a liquid state. For example, the reservoir unit(s) 320 may contain liquid helium (He) or other similar cryogenic fluid in a liquid state. In an embodiment, substantially all of the internal volume of the reservoir unit(s) 320 may be filled with liquid cooling fluid 318. For example, in an embodiment, at least 95% (e.g., at least 97%, 98%, or 99%) of the internal volume of the reservoir unit(s) 320 may be filled with cooling fluid 318 in a liquid state when a desired operational temperature (e.g., less than 5 K) for the field winding assembly 310 has been established.

It should be appreciated that in so far as the reservoir unit(s) 320 may be substantially filled with liquid cooling fluid, a warming of the cooling fluid 318 resulting from the mechanical energy of the cooling fluid sloshing in the reservoir unit(s) 320 may be mitigated/eliminated. Accordingly, the reservoir unit(s) 320 may be formed so as to have an absence of internal obstructions, such as baffles.

It should be further appreciated that, in an embodiment, the volume of cooling fluid 318 required by the cooling system 316 in order to achieve and maintain the desired operational temperature for the field winding assembly 310 may make it desirable to employ a plurality of reservoir units 322. In such an embodiment, each reservoir unit 320 of the plurality of reservoir units 322 may be fluidly coupled to each additional reservoir unit 320. In such an embodiment, a first reservoir unit 324 of the plurality of reservoir units 322 may have a first volume. Additionally, a second reservoir unit 326 of the plurality of reservoir units 322 may have a second volume. In an embodiment, the first volume may be different than the second volume.

In an embodiment, the reservoir unit(s) 320 may have a maximal length (L) and a maximal width (W). For example, the reservoir unit(s) 320 may be generally cylindrical. As such, the maximal length (L) may be greater than the maximal width (W). Additionally, the maximal length (L) may, for example, be oriented in a manner which facilitates a positioning of the generator 300 within the nacelle 106 in compliance with spatial limitations (e.g., a maximal outer diameter for the generator 300 of less than 9.6 meters) imposed by the nacelle 106. Accordingly, the maximal length (L) may be oriented parallel to the axis (A), perpendicular to the axis (A), or at any angle thereto. The reservoir unit(s) 320 may also have a cross-sectional shape defined by a plane oriented perpendicular to the maximal length (L). In an embodiment, the reservoir unit(s) 320 may have a generally circular cross-sectional shape. In an additional embodiment, the reservoir unit(s) 320 may have a non-circular cross-sectional shape. For example, spatial limitations of the nacelle 106 may make it desirable to form the reservoir unit(s) 320 to have cross-sectional shape which is an oval or other similar shape. Additionally, it should be appreciated that at least one reservoir unit 320 of the plurality of reservoir units 322 may have a different cross-sectional shape and/or size relative to the remaining reservoir units 320.

Referring still to FIGS. 2-4, the cooling system 316 may, in an embodiment, include a plurality of expansion units 328. The plurality of expansion is 328 may be fluidly coupled to the reservoir unit(s) 320. As such, the plurality of expansion units 328 may contain a portion of the cooling fluid 318 in a gaseous state. For example, the plurality of expansion is 328 may contain a portion of gaseous helium which may have vaporized from the liquid helium contained by the reservoir unit(s) 320.

In an embodiment, substantially all of the internal volume of the plurality of expansion units 328 may be filled with gaseous cooling fluid 318. For example, in an embodiment, at least 95% (e.g., at least 97%, 98%, or 99%) of the internal volume of the plurality of expansion units 328 may be filled with cooling fluid 318 in a gaseous state when the desired operational temperature for the field winding assembly 310 has been established. It should be appreciated that in so far as the plurality of expansion units 328 may be substantially filled with gaseous cooling fluid 318, it may be unnecessary to mitigate or eliminate the warming of the fraction of cooling fluid 318 in a liquid state due to sloshing. Accordingly, the plurality of expansion units 328 may be formed so as to have an absence of internal obstructions, such as baffles. It should further be appreciated that the utilization of the reservoir unit(s) in conjunction with the 320 plurality of expansion units 328 may facilitate the implementation of vibration mitigation methods, which may mitigate/eliminate an impact of a vibrational heat load on the cooling fluid 318.

As particularly depicted in the simplified cross-sectional view of the longitudinal portion of FIG. 2, in an embodiment, the cooling system 316 may include a conduit network 330. The conduit network 330 may be fluidly coupled to the reservoir unit(s) 320 and configured to circulate a portion of the cooling fluid 318. The portion of the cooling fluid 318 may be circulated via the conduit network 330 adjacent to the field winding assembly 310. By circulating the portion of the cooling fluid 318 adjacent to the field winding assembly 310, a quantity of heat may be absorbed from the field winding assembly 310 by the cooling fluid 318.

In an embodiment, wherein the cooling system 316 may include a recondenser 332. The recondenser 332 may be disposed between a return portion 334 of the conduit network 330 and the reservoir unit(s) 320. As such, the recondenser 332 may be configured to recondense a gaseous portion of the cooling fluid 318. In such an embodiment, the recondenser 332 may include a plurality of cryocoolers 336 disposed within a corresponding plurality of liquefaction cups 338. For example, in an embodiment, the recondenser 332 may include at least four cryocoolers 336 and corresponding liquefaction cups 338. It should be appreciated that the utilization of at least four cryocoolers 336 may include at least one backup cryocooler 336, and may, therefore, facilitate a continued operation of the generator 300 in the presence of a fault within the cooling system 316. It should further be appreciated that when employed in an offshore wind turbine 100, access to repair the wind turbine 100 may be limited. Therefore, the ability to operate the generator 300 in the presence of a cooling system fault may be particularly desirable.

As particularly depicted in the simplified cross-sectional view of a lateral portion of the generator 300 of FIG. 3, in an embodiment, the cooling system 316 may be a closed-loop, thermosiphon cryogenic cooling system. In such an embodiment, the reservoir unit(s) 320 may be positioned above the field winding assembly 310 along a vertical axis (V). With the reservoir unit(s) 320 being positioned vertically above the field winding assembly 310, the portion of the cooling fluid 318 may be introduced into the conduit network 330 via a gravity feed.

It should be appreciated that, as a thermosiphon cryogenic cooling system, the cooling system 316 may be configured as a passive cooling system having an absence of the pump(s) (e.g., cryogenic pumps) relied upon in an active cooling system. In place of the pump(s) of the active cooling system, the force of gravity may be leveraged by the thermosiphon cryogenic cooling system to introduce the portion of the cooling fluid 318 into the conduit network 330. As the portion of the cooling fluid 318 is circulated adjacent to the field winding assembly 310, a quantity of heat may be transferred from the field winding assembly 310 to the portion of the cooling fluid 318. The heat transfer may result in a plurality of gaseous bubbles being entrained by the cooling fluid 318 and the establishment of a flow toward the recondenser 332 without the assistance of pumps. The recondenser 332 may then be fluidly coupled to a lower face 340 of the reservoir unit(s) 320 so as to return a re-condensed portion of the cooling fluid 318 thereto.

In an embodiment wherein the cooling system 316 is configured as a thermosiphon cryogenic cooling system, the plurality of expansion units 328 may be positioned above the reservoir unit(s) 320 and adjacent thereto. The positioning of the plurality of expansion units 328 above the reservoir unit(s) 320 may facilitate a flow of a gaseous portion of the cooling fluid 318 from the reservoir unit(s) 320 to the plurality of expansion is 328 without the assistance of pumps.

Referring now to FIGS. 2 and 3, in an embodiment, the cooling system 316 may include a first plurality of toroidal expansion units 342. The first plurality of toroidal expansion units 342 may circumscribe the axis (A) adjacent to the first axial position (A₁). Each toroidal expansion unit of the first plurality of toroidal expansion units 342 may have an enclosed volume defined by a tubular wall 344. Additionally, the first plurality of toroidal expansion units 342 may be fluidly coupled to the conduit network 330.

In an embodiment, the cooling system 316 may include a second plurality of toroidal expansion units 346. The second plurality of toroidal expansion you 346 may circumscribe the axis (A) adjacent to the second axial position (A₂). Each toroidal expansion unit of the second plurality of toroidal expansion units 346 may have an enclosed volume defined by the tubular wall 344. Additionally, the second plurality of toroidal expansion units 346 may be fluidly coupled to the conduit network 330.

The first plurality of toroidal expansion is 342 and/or the second plurality of toroidal expansion units 346 may be employed during a cooldown operation wherein the temperature of the field coil assembly 310 is brought to a desired operating temperature (e.g., less than 5 K). For example, in an embodiment employing Nb3Sn, or other similar superconductors, the desired operating temperature may be less than 10 K. Additionally, the first plurality and/or second plurality of toroidal expansion units 342, 346 may serve as a reservoir to receive a portion of the cooling fluid 318, in gaseous form, in the event of a warming of the cooling fluid 318 above the desired operating temperature. For example, the first plurality and/or second plurality of toroidal expansion is 342, 346 may serve as a safety feature whereby unanticipated portions of the gaseous cooling fluid may be captured and recovered without damaging other components of the cooling system 316 in response to a cooling system fault.

Referring still to FIGS. 2 and 3, in an embodiment, the generator 300 may include a vacuum vessel 348. The vacuum vessel 348 (e.g., vacuum chamber) may encapsulate any or all of the field winding assembly 310, the reservoir unit(s) 320, the plurality of expansion units 328, the conduit network 330, the first plurality of toroidal expansion units 342, the second plurality of toroidal expansion units 346, and at least a portion of the recondenser 332. The vacuum vessel 348 may be a chamber configured to facilitate the establishment of vacuum/near-vacuum conditions within an inner volume thereof. It should be appreciated that the establishment of the vacuum/near-vacuum conditions within vacuum vessel 348 may facilitate the establishment and maintenance of the desired operating temperature (e.g. 4 K to less than 5K) of the superconducting coils 312.

In an embodiment, a thermal shield 350 (e.g., a thermal barrier) may be disposed within the vacuum vessel 348. The thermal shield 350 may be configured as a multilayer insulation. Accordingly, the thermal shield 350 may be configured to mitigate a heat transfer to the field winding assembly 310, as such a heat transfer may reduce the ability of the cooling system 316 to maintain a desired operational temperature of the field winding assembly 310.

In an embodiment, the first plurality and/or second plurality of toroidal expansion units 342, 346 may be disposed within the thermal shield 350. It should be appreciated that, in contrast to the utilization of single toroidal tanks, the utilization of the plurality of toroidal expansion units may facilitate the positioning of the first plurality and/or second plurality of toroidal expansion units 342, 346 within the thermal shield 350. For example, in an embodiment wherein the cross-sectional area of a single toroidal tank may exceed a spatial limit within the thermal shield 350, the reduced cross-sectional area of each toroidal expansion unit of the first and/or second pluralities of toroidal expansion units 342, 346 may be accommodated within the thermal shield 350.

It should be further appreciated that maintaining the first plurality and/or second plurality of toroidal expansion units 342, 346 at the desired operating temperature of the field winding assembly 310 may be beneficial to the operation of the cooling system 316. For example, a “ride-through time” for the generator 300 following a cooling system fault may represent a period of time in which the operating temperature of the field winding assembly 310 remains sufficiently low so as to permit continued operation of the generator 300. To that end, maintaining the first and/or second pluralities of toroidal expansion units 342, 346 at an operating temperature of 5 K or less may increase a ride-through time over a ride-through time available when the first and second pluralities of toroidal expansion units 342, 346 are maintained at higher temperatures (e.g. 50 K). In other words, maintaining the first and/or second pluralities of toroidal expansion use 342, 346 at the desired operating temperature may permit the generator 300 to remain in operation for a longer period and may, therefore, increase an opportunity to correct the cooling system fault prior to a system shutdown.

As depicted in FIG. 2, in an embodiment at least one toroidal expansion unit 352 of the first plurality and/or second plurality of toroidal expansion units 342, 346 may be positioned in contact with the thermal shield 350. Positioning at least one toroidal expansion unit 352 in contact with the thermal shield 350 may increase the stiffness of the thermal shield.

In an embodiment, at least one toroidal expansion unit 352 of the first and/or second pluralities of toroidal expansion units 342, 346 may have a non-circular cross-sectional shape. For example, in an embodiment, the tubular wall 344 may be formed as a squared tubular wall 344 having a polygonal cross-sectional shape, such as a square or rectangular cross-sectional shape.

The tubular wall 344 for each toroidal expansion unit of the first and/or second pluralities of toroidal expansion units 342, 346 may have a wall thickness of less than or equal to 5 millimeters. In contrast, in known systems utilizing single toroidal tanks, the wall thickness of the single toroidal tanks may exceed 15 millimeters. Accordingly, the utilization of toroidal expansion units having a wall thickness of less than or equal to 5 millimeters may be particularly beneficial. For example, do, at least in part, to the reduced wall thickness, the first plurality and/or second plurality of toroidal expansion units 342, 346 may weigh less per unit of volume than a corresponding single toroidal tank. Additionally, the reduced wall thickness of the toroidal expansion units may decrease a degree of technical difficulty in the formation of the toroidal expansion units having diameters in excess of 8 meters (e.g., in excess of 9 meters) as compared to the technical difficulty inherent in the forming a similarly sized single toroidal tank having a wall thickness that exceeds 15 millimeters.

Referring still to FIGS. 2-4, the design pressures and the internal volumes of the reservoir unit(s) 320, the plurality of expansion units 328, the first plurality of toroidal expansion units 342 and/or the second plurality of toroidal expansion units 346 may correspond to various pressure-volume testing limits. The various pressure-volume testing limits may correspond to various maximal testing pressures and testing durations which may be required based on the pressure-volume product of the corresponding unit. The pressure-volume testing limit may be a value that represents the pressure of the vessel multiplied by the volume of the vessel. For example, a large-volume pressure vessel designed to hold a fluid at a relatively high pressure may be required to maintain a higher pressure for a longer testing period than may be required for a large-volume pressure vessel designed to hold the fluid at a relatively low pressure. These testing limits may be directed to decreasing risk of potential harm in the event of vessel failure. However, this harm may be mitigated/reduced via the employment of units as described herein whereby the required volume is divided amongst multiple units for a given pressure. It should be appreciated that each of the reservoir unit(s) 320, the plurality of expansion units 328, the first plurality of toroidal expansion units 342 and/or the second plurality of toroidal expansion units 346 may be configured to have an initial operating pressure of less than or equal to 15 MPa (e.g., at least 8 MPa to less than or equal to 15 MPa).

By way of further illustration, for an initial operating pressure of 10 MPa, the test pressure may be 13 MPa. As such, the pressure-volume product for a single pressure vessel may, for example, be 10,000 (e.g., 100 bars multiplied by 100 liters). Such a pressure-volume product may result in a classification of the pressure vessel into TUV Rheinland Test Group VI or Test Group VII, and may, therefore, require additional testing/inspections than may be required for pressure vessels in test groups I through V.

As the additional testing/inspection requirements of the exemplary configuration discussed above may be undesirable, it may be beneficial to establish the pressure-volume product at a level below a pressure-volume testing limit. For example, instead of a single 100-liter pressure vessel, ten, 10-liter tanks may be employed. In such a configuration the pressure-volume product for each pressure vessel may be 1,000 (e.g., 100 bars multiplied by 10 liters). Such a pressure-volume product may result in a classification of the pressure vessels into TUV Rheinland Test Group III (instead of Test Group VI or Test Group VII) yet provide the same cumulative storage volume and pressure capacity as the single, 100-liter pressure vessel. As Test Group III pressure vessels, the satisfaction of the inspection/testing requirements may be less burdensome than may be required for Test Groups VI or VII. It should be appreciated that the particular pressures and volumes discussed above are provided for illustration purposes and are not intended to be limiting.

In accordance with the present disclosure, the cooling system 316 may be configured to hold portions of the cooling fluid 318 at particular operating pressures in each of the system units (e.g., the reservoir unit(s) 320, the plurality of expansion units 328, the first plurality of toroidal expansion units 342 and/or the second plurality of toroidal expansion units 346). As such, the pressures in each system unit may be essentially constrained to a particular range. Therefore, the relationship of each system unit to the pressure-volume product limit may be determined by the internal volume of each system unit, which is, in turn, determined by the dimensions of each system unit. Accordingly, in an embodiment, the dimensions, and thus the volume, of each of the reservoir unit(s) 320, the plurality of expansion units 328, the first plurality of toroidal expansion units 342 and/or the second plurality of toroidal expansion units 346 may be determined in consideration of a corresponding pressure-volume testing limit. In other words, the volume required by the cooling system 316 for each function may be divided across a plurality of units (e.g. the reservoir unit(s) 320 and the plurality of expansion units 328) so as to preclude the exceeding of the pressure-volume testing limit.

For example, in an embodiment, a maximal pressure-volume product for each reservoir unit(s) 320, or plurality of reservoir units 322, may be less than a pressure-volume testing limit. In an additional embodiment, a maximal pressure-volume product for each expansion unit of the plurality of expansion units 328 may be less than the pressure-volume testing limit. In a further embodiment, a maximal pressure-volume product for each toroidal expansion unit of the first and/or second pluralities of toroidal expansion units 342, 346 may be less than the pressure-volume testing limit.

In contrast with the present disclosure, it should be appreciated that the volume of the cooling fluid 318 required by the closed-loop cooling system 316 may result in a pressure-volume product which exceeds the pressure-volume testing limit when a single, bulky storage tank is employed in lieu of the reservoir unit(s) 320 and the fluidly connected plurality of expansion units 328 as disclosed herein. As such, the testing requirements, and increased structure necessary to meet the test requirements, may be greater when the single, bulky storage tank is employed. Similarly, when single toroidal tanks are employed in lieu of the first and/or second pluralities of toroidal expansion tanks 342, 346, the greater volume of a single tank at a given pressure may necessitate the more rigorous testing and corresponding increase in structure than may be required when employing the first and/or second plurality of toroidal expansion takes 342, 346.

Referring again to FIG. 4, in an embodiment, each of the plurality of reservoir units 322 may be fluidly coupled to each additional reservoir unit 320. Additionally, in an embodiment, each of the plurality of reservoir units 322 may be fluidly coupled to each of the plurality of expansion units 328. The fluid coupling between the plurality of reservoir units 322 and the plurality of expansion units 328 may, for example, be accomplished via a manifold 354. In other words, the manifold 354 may intercouple the plurality of expansion units 328 and the plurality of reservoir units 322. In such an arrangement, the cooling system 316 may have a ratio of reservoir units 320 to expansion units 328 of at least 1.0:1.5. In other words, in an embodiment, the cooling system 316 may include at least 1.5 expansion units 328 for each reservoir unit 320 in order to support the required volume of cooling fluid 318 as a closed-loop cooling system 316.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

Clause 1. A generator, comprising: a non-rotatable component supporting a field winding assembly, the non-rotatable component extending between a first axial position and a second axial position and having an annular cross-sectional shape circumscribing an axis; an armature winding assembly fixedly coupled to a rotatable component so as to rotate therewith relative to the non-rotatable component during an operation of the generator; and a cooling system operably coupled to the field winding assembly, the cooling system comprising: at least one reservoir unit containing a cooling fluid in a liquid state, a plurality of expansion units containing the cooling fluid in a gaseous state fluidly coupled to the at least one reservoir unit, a conduit network fluidly coupled to the at least one reservoir unit configured to circulate a portion of the cooling fluid adjacent to the field winding assembly so as to cool the field winding assembly, a first plurality of toroidal expansion units circumscribing the axis adjacent the first axial position, and a second plurality of toroidal expansion units circumscribing the axis adjacent the second axial position, wherein each toroidal expansion unit of the first and second pluralities of toroidal expansion units has an enclosed volume defined by a tubular wall, wherein the first and second pluralities of toroidal expansion units are fluidly coupled to the conduit network.

Clause 2. The generator of clause 1, wherein the generator is a superconducting generator, and the field winding assembly is a superconducting field winding assembly.

Clause 3. The generator of any preceding clause, wherein the cooling system is a cryogenic cooling system, the cooling fluid is a cryogenic cooling fluid, and wherein the cooling system further comprises: a recondenser disposed between a return portion of the conduit network and the at least one reservoir unit and configured to re-condense a gaseous portion of the cooling fluid; and a plurality of cryocoolers disposed within a corresponding plurality of liquefaction cups of the recondenser.

Clause 4. The generator of any preceding clause, wherein the cryogenic cooling system is a thermosiphon cryogenic cooling system, wherein: the at least one reservoir unit is positioned above the field winding assembly along a vertical axis such that the portion of the cooling fluid is introduced into the conduit network via a gravity feed; the plurality of expansion units are positioned above the at least one reservoir unit and adjacent thereto; a quantity of heat is transferred from the field winding assembly to the portion of the cooling fluid resulting in a plurality of gaseous bubbles entrained by the cooling fluid and the generation of a flow toward the recondenser; and the recondenser is fluidly coupled to a lower face of the at least one reservoir unit so as to return a re-condensed portion of the cooling fluid thereto.

Clause 5. The generator of any preceding clause, further comprising: a vacuum vessel encapsulating the field winding assembly, the at least one reservoir unit, the plurality of expansion units, the conduit network, the first plurality of toroidal expansion units, the second plurality of toroidal expansion units, and at least a portion of the recondenser.

Clause 6. The generator of any preceding clause, further comprising: a thermal shield disposed within the vacuum vessel, wherein the thermal shield surrounds and is spaced apart from the field winding assembly, and wherein the first and second pluralities of toroidal expansion units are disposed within the thermal shield.

Clause 7. The generator of any preceding clause, wherein the at least one reservoir unit further comprises a plurality of reservoir units, wherein each of the plurality of reservoir units is fluidly coupled to each additional reservoir unit of the plurality of reservoir units and to each of the plurality of expansion units.

Clause 8. The generator of any preceding clause, wherein each of the plurality of reservoir units, each of the plurality of expansion units, and each of the first and second pluralities of toroidal expansion units further comprise: a maximal pressure-volume product for each reservoir unit of the plurality of reservoir units that is less than a pressure-volume testing limit; a maximal pressure-volume product for each expansion unit of the plurality of expansion units that is less than the pressure-volume testing limit; and a maximal pressure-volume product for each toroidal expansion unit of the first and second pluralities of toroidal expansion units that is less than the pressure-volume testing limit.

Clause 9. The generator of any preceding clause, wherein the plurality of reservoir units and the plurality of expansion units are fluidly intercoupled via a manifold.

Clause 10. The generator of any preceding clause, wherein the plurality of reservoir units further comprises: a first reservoir unit of the plurality of reservoir units having a first volume; and a second reservoir unit of the plurality of reservoir units having a second volume, wherein the first volume is different than the second volume.

Clause 11. The generator of any preceding clause, wherein a reservoir unit of the plurality of reservoir units further comprises: a maximal length; and a cross-sectional shape defined by a plane oriented perpendicular to the maximal length, the cross-sectional shape being non-circular.

Clause 12. The generator of any preceding clause, wherein each of the plurality of reservoir units and each of the plurality of expansion units have a single, unitary internal volume uninterrupted by a baffle.

Clause 13. The generator of any preceding clause, further comprising: a ratio of reservoir units to expansion units of at least 1.0:1.5.

Clause 14. The generator of any preceding clause, wherein at least one toroidal expansion unit of the first plurality of toroidal expansion units or the second plurality of toroidal expansion units is positioned in contact with the thermal shield so as to increase a stiffness thereof.

Clause 15. The generator of any preceding clause, wherein at least one toroidal expansion unit of the first plurality of toroidal expansion units or the second plurality of toroidal expansion units has a non-circular cross-sectional shape.

Clause 16. The generator of any preceding clause, wherein each toroidal expansion unit of the first and second pluralities of toroidal expansion units has a wall thickness of less than or equal to 5 millimeters.

Clause 17. A wind turbine, comprising: a rotor having a plurality of rotor blades; and a superconducting generator operably coupled to the rotor and positioned a nacelle of the wind turbine, the superconducting generator comprising: a non-rotatable component supporting a superconducting field winding assembly, the non-rotatable component extending between a first axial position and a second axial position and having an annular cross-sectional shape circumscribing an axis, an armature winding assembly fixedly coupled to a rotatable component so as to rotate therewith relative to the non-rotatable component in response to a rotation of the rotor, and a closed-loop, thermosiphon cryogenic cooling system (cooling system) operably coupled to the superconducting field winding assembly, the cooling system comprising: at least one reservoir unit containing a cryogenic cooling fluid in a liquid state, the at least one reservoir unit being positioned above a the superconducting field winding assembly, a plurality of expansion units containing the cryogenic cooling fluid in a gaseous state fluidly coupled to the at least one reservoir unit, the plurality of expansion units being positioned above the at least one reservoir unit and adjacent thereto, a conduit network fluidly coupled to the at least one reservoir unit so as to receive a portion of the cryogenic cooling fluid via a gravity feed, the conduit network being configured to circulate a portion of the cryogenic cooling fluid adjacent to the superconducting armature winding assembly so as to cool the superconducting armature winding assembly, a recondenser disposed between a return portion of the conduit network and the at least one reservoir unit and configured to re-condense a gaseous portion of the cryogenic cooling fluid by removing a quantity of heat, the recondenser being fluidly coupled to a lower face of the at least one reservoir unit so as to return a re-condensed portion of the cryogenic cooling fluid thereto, a first plurality of toroidal expansion units circumscribing the axis adjacent the first axial position, and a second plurality of toroidal expansion units circumscribing the axis adjacent the second axial position, wherein each toroidal expansion unit of the first and second pluralities of toroidal expansion units has an enclosed volume defined by a tubular wall, wherein the first and second pluralities of toroidal expansion units are fluidly coupled to the conduit network.

Clause 18. The wind turbine of any preceding clause, further comprising: a vacuum vessel encapsulating the superconducting field winding assembly, the at least one reservoir unit, the plurality of expansion units, the conduit network, the first plurality of toroidal expansion units, the second plurality of toroidal expansion units, and at least a portion of the recondenser; and a thermal shield disposed within the vacuum vessel and surrounding and spaced apart from the field winding assembly, wherein the first and second pluralities of toroidal expansion units are disposed within the thermal shield.

Clause 19. The wind turbine of any preceding clause, wherein the at least one reservoir unit further comprises a plurality of reservoir units, wherein each of the plurality of reservoir units is fluidly coupled to each additional reservoir unit of the plurality of reservoir units and to each of the plurality of expansion units via a manifold.

Clause 20. The wind turbine of any preceding clause, wherein each of the plurality of reservoir units, each of the plurality of expansion units, and each of the first and second pluralities of toroidal expansion units further comprise: a maximal pressure-volume product for each reservoir unit of the plurality of reservoir units which is less than a pressure-volume testing limit; a maximal pressure-volume product for each expansion unit of the plurality of expansion units which is less than the pressure-volume testing limit; and a maximal pressure-volume product for each toroidal expansion unit of the first and second pluralities of toroidal expansion units which is less than the pressure-volume testing limit.

What is claimed is:

1. A generator, comprising:
a non-rotatable component supporting a field winding assembly, the non-rotatable component extending between a first axial position and a second axial position and having an annular cross-sectional shape circumscribing an axis;
an armature winding assembly fixedly coupled to a rotatable component so as to rotate therewith relative to the non-rotatable component during an operation of the generator; and
a cooling system operably coupled to the field winding assembly, the cooling system comprising:
at least one reservoir unit containing a cooling fluid in a liquid state,
a plurality of expansion units containing the cooling fluid in a gaseous state fluidly coupled to the at least one reservoir unit,
a conduit network fluidly coupled to the at least one reservoir unit configured to circulate a portion of the cooling fluid adjacent to the field winding assembly so as to cool the field winding assembly,
a first plurality of toroidal expansion units circumscribing the axis adjacent the first axial position, and
a second plurality of toroidal expansion units circumscribing the axis adjacent the second axial position, wherein each toroidal expansion unit of the first and second pluralities of toroidal expansion units has an enclosed volume defined by a tubular wall, wherein the first and second pluralities of toroidal expansion units are fluidly coupled to the conduit network.

2. The generator of claim 1, wherein the generator is a superconducting generator, and the field winding assembly is a superconducting field winding assembly.

3. The generator of claim 2, wherein the cooling system is a cryogenic cooling system, the cooling fluid is a cryogenic cooling fluid, and wherein the cooling system further comprises:
a recondenser disposed between a return portion of the conduit network and the at least one reservoir unit and configured to re-condense a gaseous portion of the cooling fluid; and
a plurality of cryocoolers disposed within a corresponding plurality of liquefaction cups of the recondenser.

4. The generator of claim 3, wherein the cryogenic cooling system is a thermosiphon cryogenic cooling system, wherein:
the at least one reservoir unit is positioned above the field winding assembly along a vertical axis such that the portion of the cooling fluid is introduced into the conduit network via a gravity feed;
the plurality of expansion units are positioned above the at least one reservoir unit and adjacent thereto;
a quantity of heat is transferred from the field winding assembly to the portion of the cooling fluid resulting in a plurality of gaseous bubbles entrained by the cooling fluid and the generation of a flow toward the recondenser; and
the recondenser is fluidly coupled to a lower face of the at least one reservoir unit so as to return a re-condensed portion of the cooling fluid thereto.

5. The generator of claim 4, further comprising:
a vacuum vessel encapsulating the field winding assembly, the at least one reservoir unit, the plurality of expansion units, the conduit network, the first plurality of toroidal expansion units, the second plurality of toroidal expansion units, and at least a portion of the recondenser.

6. The generator of claim 5, further comprising:
a thermal shield disposed within the vacuum vessel, wherein the thermal shield surrounds and is spaced apart from the field winding assembly, and wherein the first and second pluralities of toroidal expansion units are disposed within the thermal shield.

7. The generator of claim 5, wherein the at least one reservoir unit further comprises a plurality of reservoir units, wherein each of the plurality of reservoir units is fluidly coupled to each additional reservoir unit of the plurality of reservoir units and to each of the plurality of expansion units.

8. The generator of claim 7, wherein each of the plurality of reservoir units, each of the plurality of expansion units, and each of the first and second pluralities of toroidal expansion units further comprise:
a maximal pressure-volume product for each reservoir unit of the plurality of reservoir units that is less than a pressure-volume testing limit;
a maximal pressure-volume product for each expansion unit of the plurality of expansion units that is less than the pressure-volume testing limit; and
a maximal pressure-volume product for each toroidal expansion unit of the first and second pluralities of toroidal expansion units that is less than the pressure-volume testing limit.

9. The generator of claim 7, wherein the plurality of reservoir units and the plurality of expansion units are fluidly intercoupled via a manifold.

10. The generator of claim 7, wherein the plurality of reservoir units further comprises:
a first reservoir unit of the plurality of reservoir units having a first volume; and
a second reservoir unit of the plurality of reservoir units having a second volume, wherein the first volume is different than the second volume.

11. The generator of claim 7, wherein a reservoir unit of the plurality of reservoir units further comprises:
a maximal length; and
a cross-sectional shape defined by a plane oriented perpendicular to the maximal length, the cross-sectional shape being non-circular.

12. The generator of claim 7, wherein each of the plurality of reservoir units and each of the plurality of expansion units have a single, unitary internal volume uninterrupted by a baffle.

13. The generator of claim 7, further comprising:
a ratio of reservoir units to expansion units of at least 1.0:1.5.

14. The generator of claim 6, wherein at least one toroidal expansion unit of the first plurality of toroidal expansion units or the second plurality of toroidal expansion units is positioned in contact with the thermal shield so as to increase a stiffness thereof.

15. The generator of claim 6, wherein at least one toroidal expansion unit of the first plurality of toroidal expansion units or the second plurality of toroidal expansion units has a non-circular cross-sectional shape.

16. The generator of claim 6, wherein each toroidal expansion unit of the first and second pluralities of toroidal expansion units has a wall thickness of less than or equal to 5 millimeters.

17. A wind turbine, comprising:
a rotor having a plurality of rotor blades; and
a superconducting generator operably coupled to the rotor and positioned a nacelle of the wind turbine, the superconducting generator comprising:
a non-rotatable component supporting a superconducting field winding assembly, the non-rotatable component extending between a first axial position and a second axial position and having an annular cross-sectional shape circumscribing an axis,
an armature winding assembly fixedly coupled to a rotatable component so as to rotate therewith relative to the non-rotatable component in response to a rotation of the rotor, and
a closed-loop, thermosiphon cryogenic cooling system (cooling system) operably coupled to the superconducting field winding assembly, the cooling system comprising:
at least one reservoir unit containing a cryogenic cooling fluid in a liquid state, the at least one reservoir unit being positioned above a the superconducting field winding assembly,
a plurality of expansion units containing the cryogenic cooling fluid in a gaseous state fluidly coupled to the at least one reservoir unit, the plurality of expansion units being positioned above the at least one reservoir unit and adjacent thereto,
a conduit network fluidly coupled to the at least one reservoir unit so as to receive a portion of the cryogenic cooling fluid via a gravity feed, the conduit network being configured to circulate a portion of the cryogenic cooling fluid adjacent to the superconducting armature winding assembly so as to cool the superconducting armature winding assembly,
a recondenser disposed between a return portion of the conduit network and the at least one reservoir unit and configured to re-condense a gaseous portion of the cryogenic cooling fluid by removing a quantity of heat, the recondenser being fluidly coupled to a lower face of the at least one reservoir unit so as to return a re-condensed portion of the cryogenic cooling fluid thereto,
a first plurality of toroidal expansion units circumscribing the axis adjacent the first axial position, and
a second plurality of toroidal expansion units circumscribing the axis adjacent the second axial position, wherein each toroidal expansion unit of the first and second pluralities of toroidal expansion units has an enclosed volume defined by a tubular wall, wherein the first and second pluralities of toroidal expansion units are fluidly coupled to the conduit network.

18. The wind turbine of claim 17, further comprising:
a vacuum vessel encapsulating the superconducting field winding assembly, the at least one reservoir unit, the plurality of expansion units, the conduit network, the first plurality of toroidal expansion units, the second plurality of toroidal expansion units, and at least a portion of the recondenser; and
a thermal shield disposed within the vacuum vessel and surrounding and spaced apart from the field winding assembly, wherein the first and second pluralities of toroidal expansion units are disposed within the thermal shield.

19. The wind turbine of claim 18, wherein the at least one reservoir unit further comprises a plurality of reservoir units, wherein each of the plurality of reservoir units is fluidly coupled to each additional reservoir unit of the plurality of reservoir units and to each of the plurality of expansion units via a manifold.

20. The wind turbine of claim 19, wherein each of the plurality of reservoir units, each of the plurality of expansion units, and each of the first and second pluralities of toroidal expansion units further comprise:
a maximal pressure-volume product for each reservoir unit of the plurality of reservoir units which is less than a pressure-volume testing limit;
a maximal pressure-volume product for each expansion unit of the plurality of expansion units which is less than the pressure-volume testing limit; and
a maximal pressure-volume product for each toroidal expansion unit of the first and second pluralities of toroidal expansion units which is less than the pressure-volume testing limit.
